(19) United States
(12) Patent Application Publication
(10) Pub. No.: US 2014/0041352 A1
(43) Pub. Date: Feb. 13, 2014

(54) Automatic Header Electronic Pitch Control

(71) Applicant: Gerald Johnson, Hesston, KS (US)

(72) Inventor: Gerald Johnson, Hesston, KS (US)

(73) Assignee: AGCO Corporation, Duluth, GA (US)

(21) Appl. No.: 14/111,880

(22) PCT Filed: Apr. 16, 2012
(86) PCT No.: PCT/US12/33721

§ 371 Date: Oct. 15, 2013

Related U.S. Application Data
(60) Provisional application No. 61/475,780, filed on Apr. 15, 2011.

(51) Int. Cl. A01D 41/14

(52) U.S. Cl. CPC A01D 41/141
USPC 56/10.2 R

(57) ABSTRACT

An agricultural machine has a harvesting header mounted on a feeder house for use in severing crops at desired elevation above a ground surface and feeding the crop to a thresher. The feeder house pivots about an axis to raise and lower the header, and the header pivots on the feeder house to adjust the fore/aft pitch angle of the header relative the feeder house so as to alter the angle of its cutterbed. A position sensor produces a signal that is representative of the rotational position of the feeder housing. A header pitch sensor produces signal that is representative of the fore/aft pitch angle of the header relative the feeder house. A header control system maintains a constant cutter bed angle as the header moves along an arc while being raised and lowered by adjusting the header pitch angle in response to movement of the feeder house.

### CROSS REFERENCE TO RELATED APPLICATIONS

This application claims priority to U.S. Provisional Application No. 61/475,780 filed Apr. 15, 2011, entitled “AUTOMATIC HEADER ELECTRONIC PITCH CONTROL”.

### BACKGROUND OF THE INVENTION

1. Field of Invention

This invention relates to crop harvesting machines of the type that use sickle bar cutters, and more particularly to those that comprise a draper gathering device.

2. Description of Related Art

Agricultural combines are used to cut and thresh crop material in the field. In operation, a header mounted on the forward end of a feeder house will sever crops at a desired elevation above the ground surface, gather the severed crops to a mouth or opening on the forward end of the feeder house, and a feeder conveyor within feeder house will move or convey the crop upwardly and rearwardly to a threshing mechanism within the combine. Threshing mechanism will then thresh grain and smaller portions of the crops from stalks, cobs, straw and the like, and discharge the grain and other smaller pieces of crop material to a cleaning system within combine for separation of the grain from material other than grain (MOG).

When operating the header, it is desirable to have the ability to adjust the height at which the crops are cut off, and adjustments in the height of the header may be required frequently, particularly in hilly and rolling fields. The header height is adjusted by pivoting or rotating feeder house. It would also be desirable to adjust the fore/aft pitch of the header to select the angle of the cutter bar to optimize crop cutting and feeding into the combine. Based on the foregoing, it would be desirable to have a header control system that automatically controls the pitch angle of the header based on changes of the header height to maintain the desired cutter bar angle with respect to the ground surface.

### OVERVIEW OF THE INVENTION

In one embodiment, the invention is directed to an agricultural machine having a harvesting header mounted on a feeder house for use in severing crops at a desired elevation above a ground surface and feeding the severed crop to a threshing mechanism within the agricultural machine. The header has a laterally extending crop cutting cutter bed. The feeder house can pivot about an axis to raise and lower the header, and the header pivot on the feeder house to adjust the fore/aft pitch angle of the header relative the feeder house so as to after the angle of the cutter bed. The agricultural machine also includes a feeder housing position sensor that produces a signal that is representative of the rotational position of the feeder housing with respect to the combine harvester. A header pitch sensor produces signal that is representative of the fore/aft pitch angle of the header relative the feeder house, The agricultural machine also includes a header control system that automatically maintains a constant cutterbar height, and a second header control system that maintains a constant cutter bed angle as the header moves along an arc while being raised and lowered by adjusting the header pitch angle in response to movement of the feeder house.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 shows a schematic view of an example embodiment of a self-propelled agricultural combine in accordance with the invention.

Corresponding reference characters indicate corresponding parts throughout the views of the drawings.

### DETAILED DESCRIPTION OF EXAMPLE EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

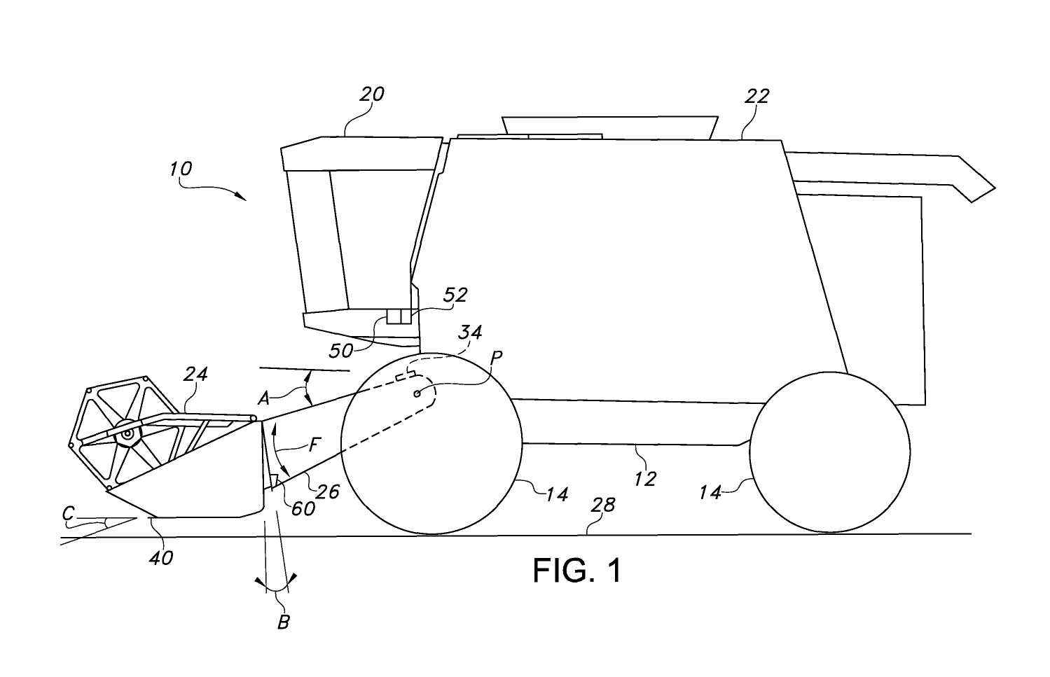

FIG. 1 shows an agricultural machine in the form of a self-propelled harvesting combine 10 operable to cut and thresh crop material in the field. Although the invention will be described using a self-propelled combine, one skilled in the art will understand that other agricultural machines, such as windrowers, may also utilize the invention disclosed herein. The combine 10 may include a chassis or frame 12 supported by wheels 14 for movement across a field to be harvested. The frame 12 carries a cab 20, within which an operator controls operation of the combine 10, and a rearwardly spaced compartment 22 housing a power source (not shown) such as an internal combustion engine. A harvesting header 24 is supported on a feeder house 26 at the front of the combine 10 in a manner understood by those skilled in the art.

Generally, in operation, the header 24 on the forward end of feeder house 26 will sever crops at a desired elevation above a ground surface denoted by line 28, gather the severed crops to a mouth or opening on the forward end of feeder house 26, and a feeder conveyor (not shown) within feeder house 26 will move or convey the crops upwardly and rearwardly to a threshing mechanism (not shown) within combine 10. Threshing mechanism will then thresh grain and smaller portions of the crops from stalks, cobs, straw and the like, and discharge the grain and other smaller pieces of crop material to a cleaning system (not shown) within combine 10 for separation of the grain from material other than grain (MOG), all in the well known manner.

As is known in the art, the header 24 has a laterally extending crop cutting assembly 40 in the form of a low profile, sickle style cutter bed located adjacent the front of the header 24 for severing crop from the ground as the combine 10 moves across a field. However, one skilled in the an will understand that other types of crop cutting assemblies 40, such as rotary style cutter beds may also be used without departing from the scope of the invention.

When operating the header 24, it is desirable to have the ability to adjust the height at which the crops are cut off, and adjustments in the height of the header 24 may be required frequently, particularly in hilly and rolling fields. The header 24 height is adjusted by pivoting or rotating feeder house 26 upwardly and downwardly about a rotational axis P adjacent a rearward end thereof. Accordingly, the front end of the feeder house 26 moves along an arc as denoted by reference F as the feeder house is rotated about axis P. Feeder house 26 is supportable in any suitable manner known in the art, such as using one or more fluid cylinders (not shown) extendable and retractable for pivotally rotating feeder house 26 about axis P for raising and lowering the header.

As is known in the art, the combine 10 has a feeder housing position sensor 34 constructed and operable according one of several known means for detecting or sensing a rotational position angle A of the feeder house 26 relative to the forward end of the combine 10, and thus the elevation of the header 24 above the ground surface 28. The feeder position sensor 32 is desirably of conventional construction and contains an electrical sensor device, such as a potentiometer or Hall effect device including circuitry which outputs a signal indicative of the rotational position of the feeder house 26 and thus the height of the header 24 above the ground surface 28. In one desirable embodiment, the feeder house position sensor 34 produces a header height sensor voltage (HV) that is representative of the header height. Conventional feeder house position sensors 34 are known to those skilled in the art, and additional detail for such position sensors need not be included herein.

A header control system 50 includes an electronic module 52 that receives the header height signal voltage HV and provides feedback to a header height adjustment system (not shown) for controlling the height of the header 24. Thus, the header control system 50 is operable to sense movement of the header 24 as the header 24 moves over uneven terrain and provides an output signal to the combine 10 for controlling the header height. Desirably, the electronic module 52 provides an output to indicate when a controller (not shown) of the combine 10 should activate solenoids to automatically raise the header 24, e.g., by hydraulically raising the feeder house 26. The feeder housing position sensor 34, electronic module 52, and header height adjustment system cooperate so that the controller of the combine automatically raises and lowers the header 24

Additionally, the fore/aft pitch angle B of the header 24 relative the feeder house 26 is adjustable to alter the angle C of the cutter bed 40 relative the ground for optimal cutting performance in addition to the draper angle to convey the crop to the feeder house 26. Hydraulic cylinders are used to adjust the fore/aft pitch angle B of the header using sound engineering judgment. Desirably, the hydraulic cylinders are capable of adjusting the pitch angle B by up to about 15 degrees, and more preferably up to about 12 degrees. Initially, the pitch angle B is desirably manually selected by activating solenoids to provide hydraulic flow to operate the hydraulic cylinders using a hydraulic system that powers other components on the header 24. A header pitch sensor 60 measures the fore/aft pitch angle B of the header 24 relative to the feeder house 26. The header pitch sensor 60 is desirably of conventional construction and contains an electrical sensor device, such as a potentiometer or Hall effect device including circuitry which outputs a signal indicative of the rotational position of the header 24. In one desirable embodiment, the header pitch sensor 60 produces a pitch sensor voltage (PV) that is representative of the pitch angle. Conventional position sensors 60 capable of measuring the pitch angle B are known to those skilled in the art, and specific detail for such position sensors need not be included herein.

As the ground terrain changes because of slopes or soft conditions, the height of the header 24 may be frequently adjusted by rotating the feeder house 26 to optimize crop cutting and feeding. Because the header 24 follows arc F as the header 24 is raised or lowered by rotating the feeder house 26, the header pitch angle B also requires adjusting to maintain the desired cutter bed angle C as the header height is changed.

According to the invention, an automatic mode of the header control system 50 is enabled such that the header 24 automatically maintains its selected cutter bed angle C as the header 24 is raised and lowered. When the feeder house 26 is moved to adjust the height of the header 24, the header control system 50 automatically adjusts the header pitch angle B to maintain the selected cutter bed angle C.

In one exemplary embodiment, the header control system 50 determines a pitch ratio (PR). The PR is calculated as follows:

PR=(PV/2*HV)*100

Where: PR=Pitch ratio

PV=Pitch sensor voltage

HV=Header height sensor voltage

In the exemplary embodiment, the factor of 2 is required because the pitch sensor has a linkage factor of 2. Of course other factors may be used depending on the orientation of the specific header and feeder house as will be understood by one skilled in the art. When the feeder house 26 is moved, the header control system 50 adjusts the header pitch angle B so as to maintain the PR within a selected tolerance. In one embodiment, the algorithm is designed for a selected tolerance of header height change, e.g., 470 mm of change, due to a maximum desired pitch angle. One skilled in the art will understand that other algorithms or methods may be used by the header control system 50 to control the hydraulic cylinders to automatically adjust the pitch angle B of the header 24 to maintain a selected cutter bed angle C.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. In an agricultural machine having a harvesting header mounted on a feeder house for use in severing crops at a desired elevation above a ground surface and feeding the severed crop to a threshing mechanism within the agricultural machine, the header having a laterally extending crop cutting cutter bed, wherein the feeder house pivots about an axis to raise and lower the header and the header pivots on the feeder house to adjust the fore/aft pitch angle of the header relative the feeder house so as to alter the angle of the cutter bed, the agricultural machine comprising:
a feeder housing position sensor that produces a signal that is representative of the rotational position of the feeder housing;
a header pitch sensor that produces signal that is representative of the fore/aft pitch angle of the header relative the feeder house; and
header control system that automatically maintains a constant cutter bed angle as the header moves along an arc while being raised and lowered by adjusting the header pitch angle in response to movement of the feeder house.

2. A method of claim 1 where the cutter bed angle can be adjusted by the operator,

3. A method of claim 1 where the cutter bed angle with respect to the combine chassis is maintained automatically as the feeder house is raised and lowered.

4. A method of claim 1 where the cutter bed angle with respect to the combine chassis can be varied as a function of the feeder house
